(19) United States
(12) Patent Application Publication
(10) Pub. No.: US 2003/0235169 A1
(43) Pub. Date: Dec. 25, 2003

(54) Wireless peer system

(76) Inventors: Anant Pandey, Troy, NY (US); Ram H. Viswanathan, Troy, NY (US); Partha Dutta, Clifton Park, NY (US); Ashwin Shankar, Lake Charles, LA (US)

Correspondence Address: HOFFMAN WARNICK & D'ALESSANDRO, LLC, 3 E-COMM SQUARE, ALBANY, NY, 12207

(21) Appl. No.: 10/175,412

(22) Filed: Jun. 19, 2002

(51) Int. Cl. H04Q 7/24

(52) U.S. Cl. 370/338; 370/310

(57) ABSTRACT

The current invention provides a wireless peer system. The wireless peer system comprises a server for storing and communicating information, at least one network peer, and a gateway peer. Each network peer communicates with the server using the gateway peer. The gateway peer and each network peer comprise a wireless communications unit and a microcontroller.

### BACKGROUND OF THE INVENTION

1. Technical Field

The current invention relates to wireless networks, and in particular, to a wireless peer network including intelligent peers.

2. Background Art

Wireless communications has allowed for a more efficient implementation of numerous new applications incorporating multiple units that are mobile and/or widely spaced, and for the implementations of applications where the need for wires would make operation difficult or impossible. The wireless capability is crucial in allowing easy installation of the units and also allowing unrestricted mobility. For example, a wireless unit can be attached to a shopping cart as it moves about a store. Further, wireless units can be installed in parking lots to provide more efficient use of parking spaces. Countless other applications can also be implemented using wireless communications.

Several wireless networks have been disclosed in the art that solve the above-mentioned applications as well as other applications. Communications for these networks are commonly implemented in a master-slave format in which the master initiates the communication, and the slaves respond. Alternatively, communications have been implemented in a peer network in which any unit can initiate communications. However, both implementations generally only include communications between a single unit and a server. Moreover, current implementations that provide for peer-to-peer communications do not provide a system for streamlining and/or reducing communication with the server over time, or the ability for peers to cooperate independent of the server to implement certain functions.

In order to ensure portability, most wireless units in existing systems contain minimal functionality. These units rely on a constant communications link with the server in order to provide the desired functionality at the unit. As the number of wireless units increases, however, the performance of the server begins to suffer under the expanded communications demand. Additionally, wireless communications may be susceptible to electronic noise or other factors that degrade the reliability of the communications link. For example, an outdoor operating environment is susceptible to the weather and the use of other wireless communication devices, and a factory environment is susceptible to the noise and interference from the various machines operating in the factory. Further, mobile wireless units may be temporarily out of range of the server or be obstructed from a direct communications path with the server.

As a result, there exists a need for a wireless peer network that eases the communications burden on the server. For example, the wireless peers can be given additional intelligence to implement functions independent of the server, and/or a dedicated peer can be provided to streamline and reduce the communications burden of the server. Further, the wireless peers can be capable of communicating and cooperating with one or more peers to implement functionality and/or communicate with the server. There exists a further need for a wireless peer network that maintains its functionality when in environments that are not conducive to wireless communications.

The current invention provides a wireless peer system comprising a server, at least one gateway peer, and a plurality of network peers. Each network peer can generally communicate with the server via a gateway peer. Each gateway peer and network peer includes a wireless communications unit and a microcontroller.

A first aspect of the invention provides a wireless peer system, comprising: a server for storing and communicating information; a plurality of network peers; a gateway peer, wherein each of the plurality of network peers communicates with the server using the gateway peer; and wherein each of the plurality of network peers and the gateway peer comprises a wireless communications unit and a microcontroller.

A second aspect of the invention provides a wireless peer system, comprising: a server for storing and communicating information; a plurality of network peers in communications with the server, wherein each of the plurality of network peers cooperates with at least one other network peer to perform a function and wherein each of the plurality of network peers comprises a wireless communications unit and a microcontroller.

A third aspect of the invention provides a wireless peer system, comprising: a server for storing and communicating information; a plurality of network peers in communications with the server, wherein each of the plurality of network peers performs self-diagnostic operations and wherein each of the plurality of network peers comprises a wireless communications unit and a microcontroller.

A fourth aspect of the invention provides a wireless shopping system, comprising: a server for storing and communicating shopping information; a plurality of mobile network peers, wherein each of the plurality of network peers is attached to an item carrier, and wherein each of the mobile network peers communicates with an input device; a gateway peer, wherein each of the plurality of mobile network peers communicates with the server using the gateway peer; and wherein each of the plurality of mobile network peers and the gateway peer comprises a wireless communications unit and a microcontroller.

A fifth aspect of the invention provides a wireless shopping system, comprising: a server for storing and communicating shopping information; a plurality of mobile network peers, wherein each of the mobile network peers communicates with an input device and an output device; at least one installed network peer, wherein the at least one installed network peer communicates with the server, and wherein the at least one installed network peer and the plurality of mobile network peers cooperate independently of the server to implement a desired function; and wherein each of the plurality of mobile network peers and the at least one installed network peer comprise a wireless communications unit and a microcontroller.

A sixth aspect of the invention provides a wireless parking system, comprising: a server for storing and communicating parking information; at least one network peer for receiving communications from at least one sensing device, wherein the at least one sensing device detects a condition of a parking space; a gateway peer, wherein the at least one network peer communicates with the server using the gateway peer; and wherein each of the at least one network peer and the gateway peer comprises a wireless communications unit and a microcontroller.

A seventh aspect of the invention provides a wireless parking system, comprising: a server for storing and communicating parking information; a plurality of uniquely identified mobile network peers; and at least one installed network peer, wherein the at least one installed network peer communicates with the server, and wherein the at least one installed network peer and the plurality of mobile network peers cooperate independently of the server to implement a desired function; and wherein each of the plurality of mobile network peers and the at least one installed network peer comprise a wireless communications unit and a microcontroller.

The exemplary aspects of the present invention are designed to solve the problems herein described and other problems not discussed, which are discoverable by a skilled artisan.

### BRIEF DESCRIPTION OF THE DRAWINGS

These and other features of this invention will be more readily understood from the following detailed description of the various aspects of the invention taken in conjunction with the accompanying drawings in which:

FIG. 1 shows a schematic representation of a wireless peer system according to one aspect of the invention;

FIG. 2 shows an exemplary schematic representation of a server;

FIG. 3 shows an exemplary schematic representation of a peer;

FIG. 4 shows a parking lot that includes a wireless peer system according to one aspect of the invention;

FIG. 5 is a side view of a parking space in the parking lot of FIG. 4;

FIG. 6 shows a store that includes a wireless peer system according to one aspect of the invention;

FIG. 7 is a side view of a shopping cart including a mobile network peer; and

FIG. 8 is a side view of a shopping basket including a mobile network peer.

It is noted that the drawings of the invention are not to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

The current invention provides a wireless peer system that includes a server, and a plurality of network peers. In one aspect, the system also includes a gateway peer. Each network peer generally communicates with the server using the gateway peer. Each network peer and gateway peer comprise a wireless communications unit and a microcontroller. Wireless communication allows for simplified installation into existing environments and buildings, and facilitates mobile components of the system. For example, the system can be installed into a parking lot to more efficiently utilize parking spaces. Additionally, the system can be incorporated into a store, allowing a customer to move freely about the store with a mobile network peer that provides the customer with helpful services.

I. Wireless Peer System

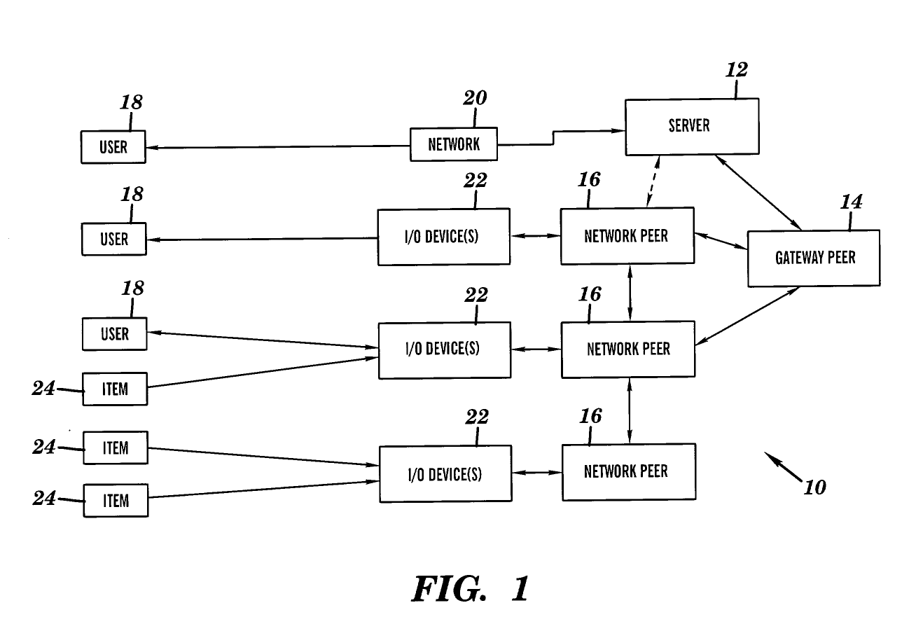

FIG. 1 shows a schematic representation of a wireless peer system 10 according to one aspect of the invention. Wireless peer system 10 is shown including a server 12, a gateway peer 14, and a plurality of network peers 16. Server 12 stores information and communicates with gateway peer 14, network peers 16, and user 18. Network peers 16 generally communicate with server 12 via gateway peer 14. However, network peers 16 can communicate directly with server 12 when, for example, communications are lost with gateway peer 14. Additionally, network peers 16 can communicate with one or more other network peers 16 to cooperate in implementing one or more desired operations and/or communicate with gateway peer 14. While a single gateway peer 14 is shown, it is understood that a plurality of gateway peers 14 can be used in wireless peer system 10.

Communications between server 12, and network peers 16 can be implemented using any wireless communications system now known or later developed. For example, wireless peer system 10 can use wireless communications that comprise one or more of radio frequency (RF), 10 infrared, ultra high frequency (UHF), very high frequency (VHF), laser transmission, short wave, etc. The use of gateway peer 14 allows the communications from various network peers 16 to be prioritized and managed apart from server 12. This allows for a smaller performance impact on server 12 when wireless peer system 10 has a large number of network peers 16. Wireless peer system 10 can be implemented such that a plurality of gateway peers 14 manages the communications between a unique subset of network peers 16 and server 12. Gateway peer 14 can further store and process information and respond to network peer 16 requests so that the required communications with server 12 further diminishes as system 10 operates.

To minimize communication requirements and any impact that a loss of communications may have on system 10, network peers 16 can operate in a self-sufficient manner. Network peers 16 can include their own memory/database so that information can be stored and used without the need for continually communicating with server 12 and/or gateway peer 14. For example, network peers 16 can retain information acquired from server 12 for future reference so that a second inquiry is not required. Network peers 16 can refresh this information based on an elapsed time since the information was last acquired and/or after a reset operation.

Network peers 16 can also communicate with one or more other network peers without the use of gateway peer 14 or server 12. A network peer 16 can use another network peer 16 to establish a communications link with gateway peer 14 and/or server 12, or acquire information from the other network peer. Network peers 16 can also be capable of cooperating with one or more network peers to perform one or more operations. This cooperation can be implemented by the two network peers 16 communicating directly or using server 12. For example, a network peer 16 may have a complex task to perform. Network peer 16 may distribute some of the work required to perform the task to a second network peer 16 that is idle. In this manner, the complex task can be performed in less time, and the resources of system 10 are used in a more efficient manner.

A group of one or more network peers 16 and/or gateway peers 14 can dynamically configure the communications environment of system 10. For example, several network peers 16 may determine that communications with server 12 is most efficient when a particular gateway peer 14 and/or network peer 16 is used as an intermediary. Consequently, these network peers 16 will route messages to server 12 using this communications path. The communications environment of system 10 can change and be reconfigured over time based upon communications demand, workload, communications performance, etc.

Each network peer 16 is intelligent and can be sufficiently self-reliant that it can continue to operate when communication with server 12 is lost totally. A network peer 16 can continue to collect, process, and store information that can subsequently be transmitted to server 12 once communications are reestablished. Additionally, each network peer 16 can perform self-diagnostic operations, i.e., when communications are lost, or certain data appears to be out of sync. A network peer 16 may self-diagnose a communication problem with server 12 by attempting to initiate communications with other network peers. Based on the success/failure of this attempt, a network peer 16 can alter its operation, use the other network peer to communicate with server 12, cooperate with one or more network peers to implement some or all of the functions, etc. For example, server 12 may have a communications backlog causing it to become less responsive. A network peer 16 may then communicate with another network peer 16 and/or gateway peer 14 to obtain the desired information.

A user 18 can interact with one or more network peers 16 through the use of one or more input/output (I/O) devices 22 when at the physical location of system 10. An I/O device 22 can communicate with a network peer 16 over an internal, external, or wireless connection. I/O devices 22 provide network peers 16 with information that each network peer 16 can subsequently process and/or transmit to I/O devices 22, gateway 14, and/or server 12. For example, an I/O device 22 can comprise a device for identifying a user 18 that has selected a particular network peer 16. Once a particular user 18 has been identified by a network peer 16, server 12 can initialize one or more of the network peers based on user information about the particular user that is stored in server 12. In addition, I/O devices 22 can include a keypad, display, or the like for communicating information to network peers 16.

When not at the physical location of system I/O, user 18 can communicate with server 12 over a network 20 (e.g., Internet, LAN, WAN, VPN, etc.). This allows user 18 to provide, modify, and/or obtain information from server 12 without traveling to the physical location of system 10. As discussed above, user information can subsequently be transmitted to one or more network peers 16 for use when user 18 is identified by a particular network peer 16. The user information can include general information about the user, information on past usage of system 10 by the user, and/or information that the user communicates to server 12 over network 20. For example, user 18 can communicate with server 12 from his/her home using an Internet connection. User 18 can provide server 12 with information that is subsequently utilized by system 10 when user 18 interacts with one or more network peers 16. User 18 can individually choose whether system 10 retains information that remains associated with their identification regarding their usage of system 10, and if so, how much information system 10 retains regarding their usage (e.g., a privacy feature). System 10 can also initialize one or more network peers 16 based on the recent usage of system 10 by all users 18.

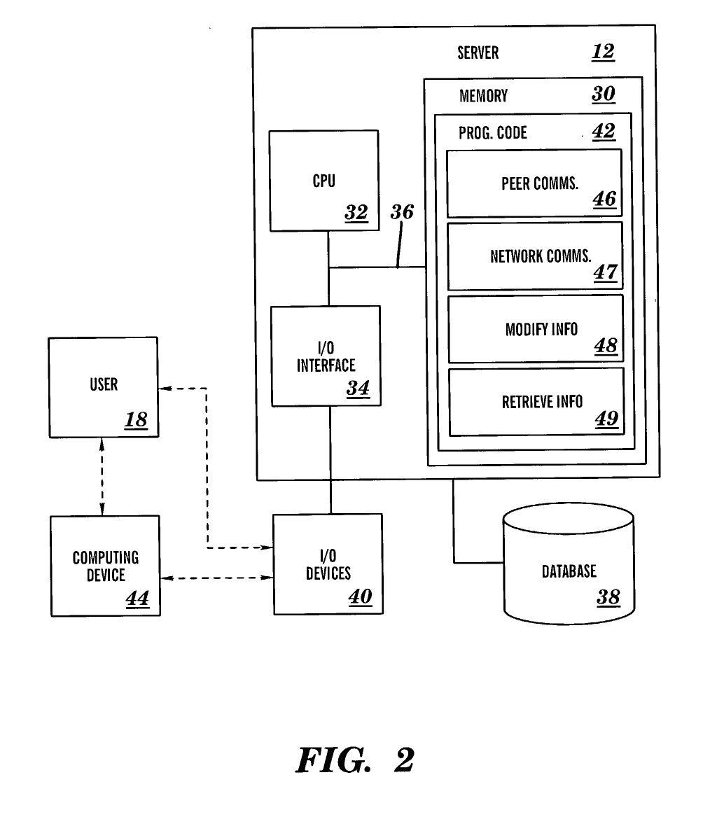

FIG. 2 is a schematic representation of an exemplary server 12 according to one aspect of the invention. As shown in FIG. 2, server 12 generally comprises memory 30, central processing unit (CPU) 32, I/O interface 34, and bus 36. A database 38 may also be provided for storage of data relative to processing tasks. Memory 30 and/or database 38 may comprise any known type of data storage and/or transmission media, including magnetic media, optical media, random access memory (RAM), read-only memory (ROM), a data cache, a data object, etc. Moreover, memory 30 and/or database 38 may reside at a single physical location, comprising one or more types of data storage, or be distributed across a plurality of physical systems in various forms. Likewise, CPU 32 may comprise a single processing unit, multiple processing units capable of parallel operation, or be distributed across one or more processing units in one or more locations, e.g., on a client and server. Server 12 can comprise an advanced mid-range multiprocessor-based server utilizing standard operating system software, which is designed to drive the operation of the particular hardware and which is compatible with other system components and I/O controllers. I/O interface 34 may comprise any system for exchanging information with one or more I/O devices 40. For example, I/O devices 40 may comprise any known type of input/output device including an I/O port (serial, parallel, ethernet, etc.), a universal serial bus (USB) controller, a network system, modem, keyboard, mouse, scanner, voice recognition system, monitor (cathode-ray tube (CRT), liquid-crystal display (LCD), etc.), printer, disc drives, etc. Bus 36 provides a communication link between each of the components in server 12 and likewise may comprise any known type of transmission link, including electrical, optical, wireless, etc. In addition, although not shown, additional components, such as cache memory, communication systems, system software, etc., may be incorporated into server 12.

User 18 can interact with server 12 to provide, modify, and/or retrieve information. To this extent, user 18 may interact with server 12 by interacting directly with I/O devices 40, and/or by interacting with another computing device 44 in communication with one or more I/O devices 40 in a network environment. Computing device 44 could communicate with server 12 via I/O devices 40 through any type of network 20 (FIG. 1) including, for example, a direct connection, a private network, a virtual private network (VPN), a local area network (LAN), a wide area network (WAN), the Internet, etc. For example, server 12 can be connected to the world wide web by using one or more I/O devices 40. User 18 can subsequently access the world wide web using computing device 44 and interact with server 12.

Program code 42 is shown stored in memory 30. Program code 42 is shown including a peer communications module 46, a network communications module 47, a modify information module 48, and a retrieve information module 49. Peer communications module 46 can implement communications between server 12 and the gateway peers and network peers that are operating in the system. Network communications module 47 can implement communications between server 12 and the one or more networks described above. Modify information module 48 can implement functions that allow users 18 over network 20, network peers 16 and/or gateway peers 14 (FIG. 1) to add, remove, and/or delete the information stored on server 12. Retrieve information module 49 can implement functions that allow the retrieval of the information stored on server 12 by users 18, network peers 16 and/or gateway peers 14.

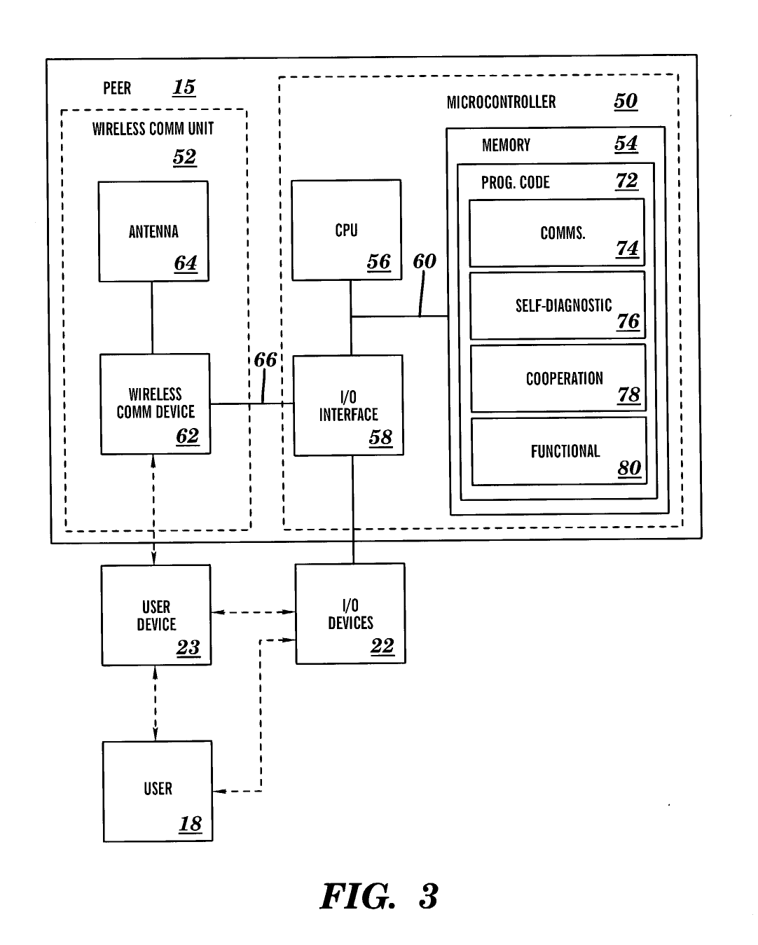

FIG. 3 is a schematic representation of an exemplary peer 15 according to the invention. Peer 15 can act as either a gateway peer 14 or a network peer 16 shown in FIG. 1. As shown in FIG. 3, peer 15 comprises a microcontroller 50 and a wireless communications unit 52. Microcontroller 50 generally comprises memory 54, CPU 56, I/O interface 58, and bus 60. Memory 54 may comprise any known type of data storage and/or transmission media, including optical media, random access memory (RAM), read-only memory (ROM), a data cache, etc. CPU 56 may comprise a single processing unit or multiple processing units capable of parallel operation. I/O interface 58 may comprise any system for exchanging information with one or more I/O devices 22. Bus 60 provides a communication link between each of the components in microcontroller 50 and likewise may comprise any known type of transmission link, including electrical, optical, wireless, etc. In addition, although not shown, additional components, such as cache memory, system software, permanent data storage, etc., may be incorporated into microcontroller 50.

Wireless communications unit 52 generally comprises a wireless communications device 62 and an antenna 64. Wireless communications device 62 communicates with microcontroller 50 through a connection 66 with I/O interface 58. Wireless communications device 62 can comprise any device that converts electrical signals to/from wireless signals using any wireless communications method, including infrared, RF, etc. Wireless communications device 62 can use single channel or multi-channel communications, and can be capable of addressing data collisions and errors without the use of microcontroller 50. Antenna 64 can comprise an appropriate external and/or internal antenna for receiving and transmitting the desired wireless communications signals.

I/O devices 22 can comprise any type of I/O device for receiving and communicating information. For example, user 18 can use one or more input devices, including a keyboard, a mouse, a touchscreen, a keypad, a voice recognition system, etc. to directly input information into peer 15. Alternatively, a user device 23, such as an identification card, smart card, a license plate, a wireless transceiver, etc. can be used in conjunction with an I/O device 22, such as a scanner, an optical recognition system, a wireless identification system, etc. to identify and/or acquire the necessary information about a particular user 18. In still another alternative, user device 23 can comprise an electronic transceiver that can communicate with wireless communications unit 52 to identify user 18. Similarly, any combination of output devices, including audio generators, displays, lights, etc. can be used by peer 15 to convey information to users 18. Peer 15 can further receive data regarding a particular item or the environment in which system 10 is operating. For example, input devices such as temperature sensing devices, object sensing devices, weight sensing devices, light sensing devices, scanners, etc. can be used to acquire information about certain items and/or the environment.

When peer 15 is a gateway peer 14 (FIG. 1), wireless communications unit 52 or an additional communications unit can be used for communicating with server 12 and/or other gateway peers 14. For example, an I/O device 22 can provide communications with server 12 over serial, parallel, ethernet, fiber optic, wireless, etc. Should communications with server 12 using one of the communications unit fail, gateway peer 14 can attempt to establish communications with server 12 and/or gateway peers 14 using the second communications unit.

Program code 72 is shown stored in memory 54. Program code 72 is shown including a communications module 74, self-diagnostic module 76, cooperation module 78, and a functional module 80. Communications module 74 can perform functions that implement the communications between peer 15, other peers and server 12. Self-diagnostic module 76 can implement the ability of peer 15 to detect and diagnose potential problems and react to the problem in an appropriate manner. Cooperation module 78 can implement the functions for allowing peer 15 to cooperate (e.g., group) with other peers in performing one or more functions. Functional module 80 can implement the particular functions that peer 15 is to perform in the system. For example, functional module 80 can implement particular methods of interfacing with certain I/O devices 22, performing certain calculations, storing, processing, and sending various information, etc.

While program code 42, 72 in FIGS. 2 & 3 are shown including the various modules that implement specific functions, it is understood that the functionality implemented by each of the modules can be implemented in fewer or more modules or in different modules. Additionally, while all the modules are shown located within memory 30, 54, it is understood that the modules can be distributed among a plurality of memory locations and implemented in a distributed or parallel fashion. The current configurations are provided for exemplary purposes only and are not intended to limit the invention to the current configurations.

The general system outlined in FIGS. 1-3 will be better understood with reference to two applications of the system. However, it is understood that the invention is not limited to these particular applications, and that these discussions are provided for clarity purposes only.

A. Wireless Parking System

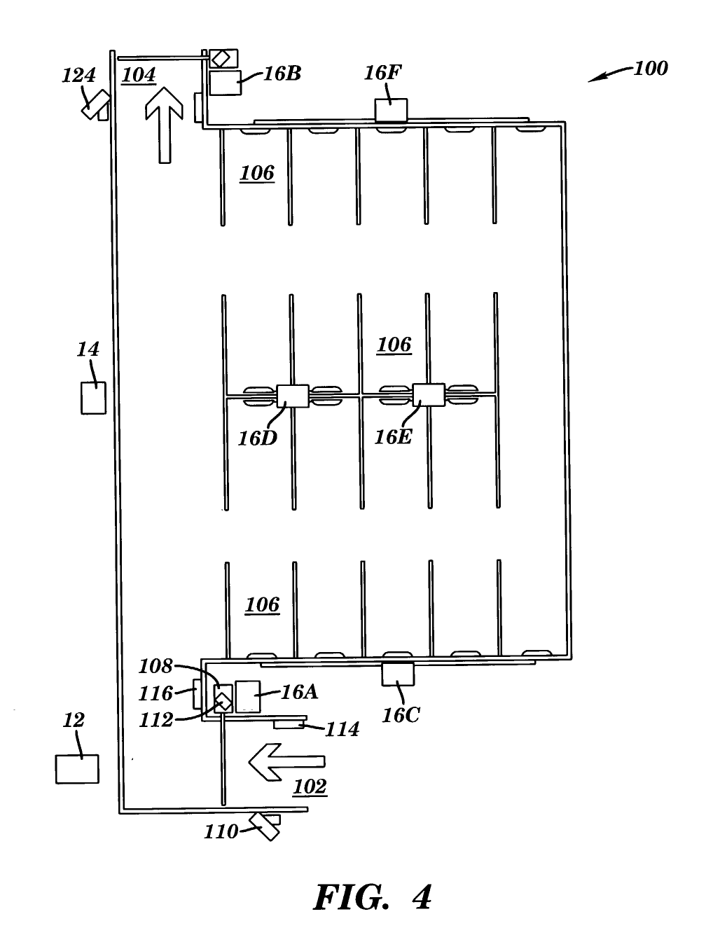

FIG. 4 shows an exemplary parking lot 100 that includes a wireless peer system according to one aspect of the invention. As shown, the parking lot includes an entrance 102, an exit 104 and a plurality of parking spaces 106. While a single entrance 102 and exit 104 are shown, it is understood that parking lot 100 can include any number of entrances 102 and exits 104. The wireless parking system is shown including a server 12, a gateway peer 14, and a plurality of network peers 16A-F. Each network peer 16A-F can be in communication with one or more I/O devices such as a sensing device, an output device, etc.

Entry network peer 16A is shown located near entrance 102 of parking lot 100. Entry network peer 16A communicates with entrance gate 108, touchscreen 110, electronic recognition device 112, and sensing devices 114, 116. In operation, entry network peer 16A can keep gate 108 lowered when no automobile is present at entrance 102. When an automobile approaches, sensing device 114 detects its presence. Entry network peer 16A then operates touchscreen 110 to welcome the user and locate a parking space 106 for the automobile. Additionally, electronic recognition device 112 (described below) can identify the user and entry network peer 16A can communicate the user's arrival to server 12 using gateway peer 14. Once an empty parking space 106 is selected, entry network peer 16A can open gate 108 to allow the automobile to pass through. Sensing device 116 can detect the automobile passing and entry network peer 16A can then close gate 108.

As noted, entry network peer 16A can operate touchscreen 110 to allow a user to select a desired parking space 106. Entry network peer 16A can maintain real-time communications with server 12 and/or other network peers 16 to provide an accurate status of the various parking spaces 106 to a user. Entry network peer 16A can provide the user with the general locations of available parking spaces 106 and then allow the user to select a desired location or a particular parking space 106 within the desired location. For example, touchscreen 110 can present a map of parking lot 100 and allow a user to press the area of parking lot 100 in which the user desires to park. Alternatively, entry network peer 16A can communicate the identification of the user to server 12 which can communicate back a desired location/parking space based on user information stored in server 12. This can include, for example, past parking spaces selected by the user or a desired parking location that the user previously entered into the system. Should an automatically selected parking space 106 not be desired, the user can be given the opportunity to override the selection and select a different space. Other possibilities for assigning a parking space 106 include selecting an available parking space 106 that is closest to a particular pedestrian exit, vehicle exit, handicap exit, etc. Particular parking spaces 106 can also be reserved for certain users, i.e., handicap parking spaces, a subset of parking spaces 106 for visitors to a business, or certain users may be given a specific parking space 106.

Entry network peer 16A is also shown in communication with an electronic recognition device 112. Electronic recognition device 112 can sense a unique electronic device placed within the automobile, can use optical character recognition to identify the license plate, or any other system now known or later developed for uniquely identifying users and/or automobiles. Alternatively, a uniquely identified mobile network peer can be placed in an automobile to communicate with entry network peer 16A when the automobile arrives at parking lot 100. Other alternatives include a user typing in an identification using touchscreen 110, a parking attendant or machine providing each user with a unique ticket, a user swiping an identification card, etc. Further, a combination of automated and manual identifiers can be used when, for example, the system is implemented in a public parking lot that includes both regular users as well as single use or infrequent users.

While entry network peer 16A is shown in communications with, and controlling various I/O devices at entrance 102, it is understood that one or more additional network peers can be used to control the required I/O devices at entrance 102. Further, various I/O devices can communicate directly with server 12 which subsequently communicates with network peers 16.

Once a parking space 106 has been assigned, entry network peer 16A can communicate the parking space to server 12 using gateway peer 14. Server 12 can then communicate to the appropriate network peer 16C-F that is monitoring the selected parking space 106. Alternatively, entry network peer 16A can communicate the selected parking space 106 to the appropriate network peer 16C-F directly, using another network peer 16B-F, using gateway peer 14, etc.

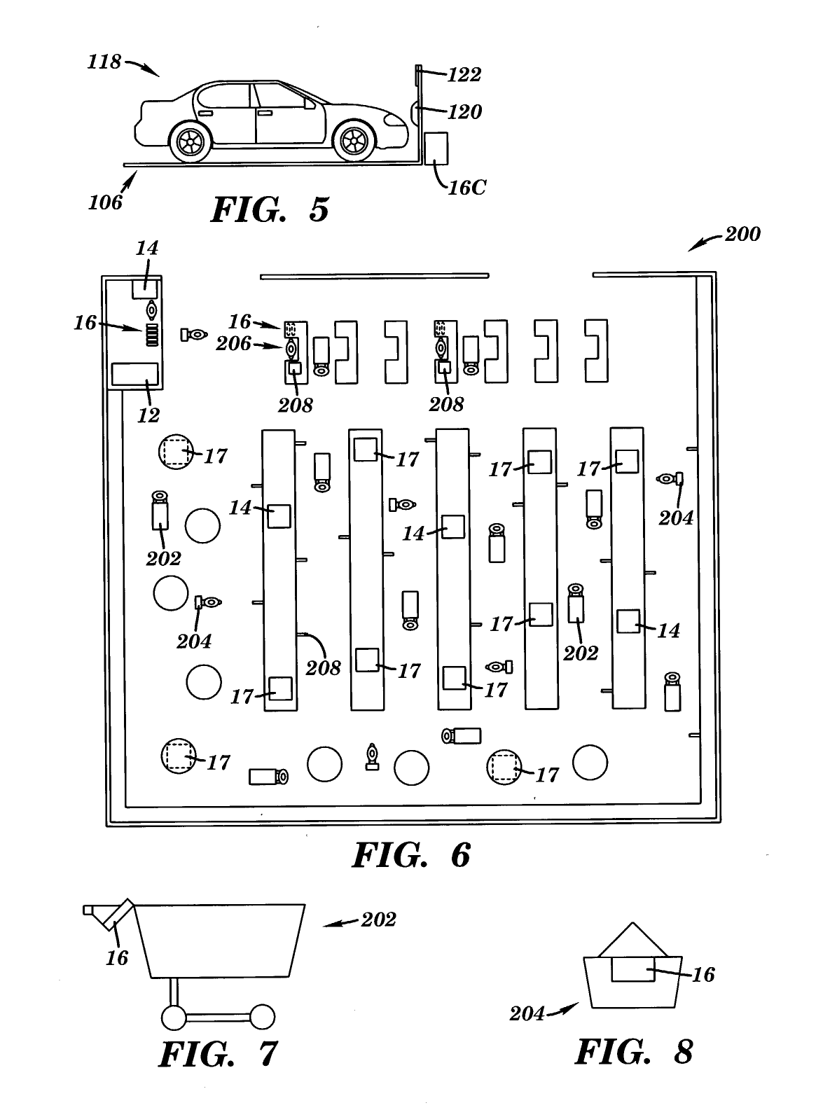

Network peers 16C-F can monitor one or more parking spaces 106 using one or more I/O devices. For example, FIG. 5 shows a side view of an exemplary parking space 106 having an automobile 118 parked therein. Network peer 16C is shown in communication with sensing device 120 and output device 122. When a parking space 106 that is being monitored by network peer 16C has been selected by a user, network peer 16C can provide a message that the parking space is reserved on output device 122. As automobile 106 pulls into parking space 106, sensing device 120 detects its presence. Network peer 16C can then communicate a welcome message to the user using output device 122. Output device 122 can comprise, for example, a text message system, an audio system, etc. Alternatively, output device 122 can comprise or one or more lights which are turned on/off accordingly (i.e., green is available, yellow is reserved, red is taken).

Returning to FIG. 4, when a network peer 16C-F has been notified that a particular parking space 106 was selected, it can enter a waiting mode for a user to arrive at the selected parking space 106. Should the user enter a parking space 106 that is not in a waiting mode (not reserved for him/her), network peer 16C-F can communicate to server 12 and/or other network peers 16C-F that a particular parking space 106 was entered without being selected. Server 12 can then communicate that parking space 106 is no longer available to entry network peer 16A. After a certain amount of elapsed time in waiting mode, network peer 16C-F can communicate to server 12 that the user did not enter the selected parking space 106. Server 12 can then notify entry network peer 16A that parking space 106 is again available. If the user parks in a parking space that has already been assigned to someone else, the network peer 16C-F monitoring the parking space can display a message regarding an alternative parking space that can be used.

Server 12 can also maintain a list of parking violations associated with a user. System 10 can incorporate a change/loss of privileges if a sufficient number of violations occur. A parking violator can be identified through an algorithm that identifies which entrant parked in an incorrect parking space. For example, when a non-reserved parking space 106 is used and a reserved parking space 106 times out, the violator is likely a user that was assigned the reserved parking space 106 but parked in the other parking space 106. Alternatively, an identification device can be provided at each parking space 106 to identify the user.

Once a user leaves a particular parking space 106, the network peer 16C-F can communicate to the server 12 that the space is available. Server 12 can then communicate to entry network peer 16A that the parking space is newly available and to network peer 16B the appropriate user information before the user exits parking lot 100. Network peer 16B can then operate display 124 to display information to the departing user. For example, display 124 can show the amount of time that the user was parked at the parking space, the total amount charged for the space, how the amount is to be paid, etc. Alternatively, this information can be displayed by a network peer 16C-F using a display 122 for the particular parking space 106.

Additional network peers and/or gateway peers can be provided in the current system. For example, a multi-tiered parking lot may include a gateway peer for each level. Additionally, network peers can be provided to provide additional functionality using sensing devices, displays, etc. For example, the motion of a car can be tracked in the parking lot to assist the driver in locating the appropriate parking space. Visual displays can be used to provide customized directions for a user to find the parking space. Additionally, a network peer can provide an interface for identifying a user and providing directions to the parking space where his/her car is located or for locating a desired exit.

Network peers 16A-F can communicate with the various I/O devices using a physical connection, a wireless connection, and any combination thereof. The I/O devices described herein are only intended as an exemplary embodiment and the invention is not limited to this implementation. The described functionality of the system is also exemplary, and numerous modifications are readily apparent and apply equally to the current invention.

B. Wireless Shopping System

FIG. 6 depicts a store 200 having a wireless shopping system installed therein. The wireless shopping system is shown including a server 12, a plurality of gateway peers 14, and a plurality of mobile network peers 16. Each mobile network peer 16 communicates to server 12 using one or more gateway peers 14. Mobile network peers 16 can be attached to an item carrier, for example, a shopping cart 202, or a shopping basket 204. FIG. 7 shows an exemplary shopping cart 202 having a mobile network peer 16 attached thereto, while FIG. 8 shows an exemplary shopping basket 204 having a mobile network peer 16 attached thereto. The location of mobile network peers 16 in FIGS. 7 and 8 are for exemplary purposes only. The mobile network peers 16 can be located and adjusted to any position desired by a user. Each mobile network peer 16 can be temporarily attached to a shopping cart 202 and/or a shopping basket 204 by any means now known or later developed, including, one or more hooks, a hook and latch system, groove, a support system, etc.

Upon arrival, a user can select a mobile network peer 16 and an item carrier to use while shopping. Each mobile network peer 16 can be individually programmed with data from server 12 based on an identified user. For example, mobile network peer 16 can identify the user using any system previously discussed (e.g., identification card, etc.) and can be initiated with information from server 12 accordingly. The user may have entered a shopping list into server 12 from home using his/her personal computer and an Internet connection. When the user is identified by a particular mobile network peer 16, server 12 can initialize the mobile network peer with the shopping list previously loaded by the user. Additionally, other user information can be sent to the particular mobile network peer 16, including purchasing history, payment information, etc.

While server 12 can store and retrieve a user's purchasing history, a user can elect to limit the type of history data stored or have none of his/her history stored on server 12. A user can elect how server 12 treats his/her history data via a user setup by accessing server 12 from home, via an I/O device on a mobile network peer 16, etc. A user can have a default action that server 12 performs with the history data, and override the action for a particular shopping trip.

FIG. 6 also shows a plurality of installed network peers 17 located throughout store 200. Installed network peers 17 can communicate with one or more I/O devices, for example displays 208, to inform customers of specials, explain missing inventory, locate products, monitor temperatures, etc. This arrangement allows customers who do not obtain a mobile network peer 16 to interact with the system. Additionally, installed network peers 17 can communicate directly with mobile network peers 16 to customize displays 208 and/or customize a display on the mobile network peer. Should either network peer 16, 17 have a communication problem with gateway 14 and/or server 12, network peer 16, 17 can attempt to reestablish communications via another network peer 16, 17.

Mobile network peers 16 and/or installed network peers 17 can include a device for identifying products that a user wishes to purchase and/or obtain information. The device can be any device now known or later developed, including devices for optically scanning product bar codes, devices for wireless communications with a product microchip that transmits an electronic product code (Auto-ID), etc. This enables the network peer to, for example, display information on the product, add the cost of the item to the user's bill, remove the item from a shopping list, communicate with an installed network peer 17 and/or server 12 to update the current inventory, etc. In this fashion, an installed network peer 17 can track the current inventory and notify server 12 when one or more products need reshelving.

When a user is ready to check out, mobile network peer 16 can be detached from the item carrier and given to a cashier 206. Mobile network peer 16 can also be placed so that it can communicate with a cash register 208. Mobile network peer 16 can communicate with cash register 208 to confirm purchases and ensure that the list of purchased items is complete. Once check out is complete, mobile network peer 16 can communicate the purchased items to server 12 for a more permanent storage and further processing. Mobile network peer 16 can then be reinitialized and redistributed to a new user.

II. Conclusion

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

What is claimed is:

1. A wireless peer system, comprising:
a server for storing and communicating information;
a plurality of network peers;
a gateway peer, wherein each of the plurality of network peers communicates with the server using the gateway peer; and
wherein each of the plurality of network peers and the gateway peer comprises a wireless communications unit and a microcontroller.

2. The system of claim 1, wherein each of the plurality of network peers communicates with an input device and an output device.

3. The system of claim 2, wherein at least one of the plurality of network peers is attached to an item carrier for use in a store, and wherein the input device comprises a device for identifying an item in the store, and the output device comprises a device for communicating shopping information to a user.

4. The system of claim 2, wherein at least one of the plurality of network peers monitors at least one parking space in a parking lot, and wherein the input device comprises at least one sensing device for determining the availability of the at least one parking space and the output device comprises a device for communicating parking information to a user.

5. The system of claim 1, wherein at least one of the plurality of network peers further comprises an input device for identifying a user.

6. The system of claim 1, wherein each of the plurality of network peers is initialized based on user information stored in the server.

7. The system of claim 6, wherein the user communicates user information to the server over a network.

8. The system of claim 6, wherein the user information includes information on past usage of the system by the user.

9. The system of claim 1, wherein at least one of the plurality of network peers further communicates with a second network peer.

10. The system of claim 9, wherein a subset of the plurality of network peers cooperate to perform an operation.

11. The system of claim 9, wherein the at least one of the plurality of network peers communicates with the gateway peer using the second network peer.

12. The system of claim 1, wherein each of the plurality of network peers further communicates with the server.

13. The system of claim 1, wherein each of the plurality of network peers performs self-diagnostic operations.

14. The system of claim 1, wherein each of the plurality of network peers operates without communication with the server.

15. A wireless shopping system, comprising:
a server for storing and communicating shopping information;
a plurality of mobile network peers, wherein each of the plurality of network peers is attached to an item carrier, and wherein each of the mobile network peers communicates with an input device;
a gateway peer, wherein each of the plurality of mobile network peers communicates with the server using the gateway peer; and
wherein each of the plurality of mobile network peers and the gateway peer comprises a wireless communications unit and a microcontroller.

16. The system of claim 15, further comprising, an installed network peer, wherein the installed network peer communicates with the server using the gateway peer, and wherein the installed network peer and at least one of the plurality of mobile network peers cooperate independently of the server to implement a desired function.

17. The system of claim 15, wherein the server further stores and communicates user information, and wherein a user communicates user information to the server over a network and at least one of the plurality of mobile network peers is initialized based on the user information.

18. The system of claim 15, wherein the input device comprises a scanner for identifying an item in the store, and the output device comprises a display for displaying shopping information to a user.

19. A wireless parking system, comprising:
a server for storing and communicating parking information;
at least one network peer for receiving communications from at least one sensing device, wherein the at least one sensing device detects a condition of a parking space; and
a gateway peer, wherein the at least one network peer communicates with the server using the gateway peer; and
wherein each of the at least one network peer and the gateway peer comprises a wireless communications unit and a microcontroller.

20. The system of claim 19, further comprising at least one entry network peer for detecting the presence of an automobile and communicating a parking space to a user driving the automobile.

21. The system of claim 20, wherein the at least one entry network peer further communicates with an input device for identifying the user.

22. The system of claim 19, wherein a user can communicate with the server over a network to request a parking space.
